(19) United States
(12) Patent Application Publication
(10) Pub. No.: US 2025/0034056 A1
(43) Pub. Date: Jan. 30, 2025

(54) BIO-ADDITIVE FOR ORGANIC FERTILIZER FROM BANANA SAP

(71) Applicant: Christopher Curzon, Charlotte, NC (US)

(72) Inventor: Christopher Curzon, Charlotte, NC (US)

(21) Appl. No.: 18/788,123

(22) Filed: Jul. 29, 2024

Related U.S. Application Data
(60) Provisional application No. 63/516,101, filed on Jul. 27, 2023.

(51) Int. Cl. C05F 11/00

(52) U.S. Cl. CPC C05F 11/00

(57) ABSTRACT

A method for creating a banana sap fertilizer. The method includes extracting fibrous materials from the banana plant pseudo-stem and separating the nonfibrous biomass and sap. The method also includes filtering the sap and concentrating the sap. The method further includes incubating the sap.

### CROSS-REFERENCE TO RELATED APPLICATIONS

This application claims the benefit of and priority to U.S. Provisional Patent Application Ser. No. 63/516,101 filed on Jul. 27, 2023, which application is incorporated herein by reference in its entirety.

### BACKGROUND OF THE INVENTION

Climate change has and continues to result in changes in weather conditions which cause challenges to agriculture, landscaping, green spaces and properties. Many areas that have historically had sufficient moisture are now more often subject to drought. Other areas are arid and have continuously struggled with sufficient water to meet growing populations and maintain agriculture.

The majority of fertilizers used globally are synthetic fertilizers. Roughly 85-90% of fertilizers used in agriculture are synthetic, while the remaining 10-15% are natural or organic fertilizers. Synthetic fertilizers are chemically manufactured and typically contain a specific blend of essential nutrients, such as nitrogen, phosphorus, and potassium, which are crucial for plant growth. They are widely used in modern agriculture due to their ability to provide plants with nutrients in readily available forms and in precise ratios. On the other hand, natural or organic fertilizers include substances like compost, manure, bone meal, and other organic materials. These fertilizers release nutrients slowly as they decompose, and they can improve soil structure and overall soil health.

The market has hundreds of synthetic fertilizers and growth materials for agriculture, commercial and residential use. The problem with synthetic fertilizers is that they are not organic and help contribute to soil damage and contamination. Moreover, some synthetic fertilizers have not been adequately studied to know their full impact on creating toxins or contaminants in food products. Finally, these fertilizers are not sustainable and use fabricated chemicals that are dangerous to the environment in the long term. Several of the challenges of synthetic fertilizers are as follows:
a) Nutrient imbalance: Synthetic fertilizers typically provide a limited range of nutrients, primarily nitrogen, phosphorus, and potassium (NPK). Continuous use of these fertilizers can lead to nutrient imbalances in the soil, depleting other essential micronutrients necessary for plant growth.
b) Soil degradation: Excessive use of synthetic fertilizers can harm soil health. They can alter the soil's physical, chemical, and biological properties, leading to soil compaction, reduced water-holding capacity, and a decline in organic matter content.
c) Water pollution: One of the most significant environmental concerns associated with synthetic fertilizers is water pollution. When excess fertilizers are applied, rainwater or irrigation can wash the unused nutrients into nearby water bodies, causing nutrient runoff. This leads to eutrophication, where an overabundance of nutrients in the water stimulates excessive algal growth, harming aquatic ecosystems and leading to “dead zones” with little or no oxygen in the water.
d) Greenhouse gas emissions: The production, transportation, and application of synthetic fertilizers require significant energy inputs, resulting in greenhouse gas emissions, particularly from the manufacturing process of ammonia (a key component of nitrogen-based fertilizers).
e) High cost: Synthetic fertilizers can be costly for farmers, particularly in developing regions. Dependency on these fertilizers can create financial burdens for small-scale farmers.
f) Decline in soil fertility over time: Prolonged and exclusive reliance on synthetic fertilizers can reduce the soil's natural fertility and organic matter content, making it increasingly dependent on external inputs for plant growth.
g) Negative impact on beneficial soil organisms: Synthetic fertilizers can harm beneficial microorganisms and earthworms in the soil, disrupting the natural ecosystem that supports plant growth and nutrient cycling.
h) Resilience to pests and diseases: Excessive use of synthetic fertilizers can lead to the growth of plants with weaker defenses against pests and diseases. This can result in the need for additional chemical inputs to combat these issues.

To address these problems, sustainable agricultural practices are being encouraged, such as crop rotation, cover cropping, organic farming, and the use of natural fertilizers like compost, manure, and biofertilizers. These practices promote soil health, reduce environmental impacts, and contribute to more resilient and sustainable agricultural systems. Hence, the market is looking for natural organic fertilizers that do not harm the environment while at the same time promote plant health and growth.

Banana sap fertilizer as a Liquid Fertilizer is unique, biodegradable, organic and cost-effective method for strengthening plants and crops.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method for creating a banana sap fertilizer. The method includes extracting fibrous materials from the banana plant pseudo-stem and separating the nonfibrous biomass and sap. The method also includes filtering the sap and concentrating the sap. The method further includes incubating the sap.

Another example embodiment includes a method for creating a banana sap fertilizer. The method includes extracting fibrous materials from the banana plant pseudo-stem and separating the nonfibrous biomass and sap. The method also includes transporting the sap to a storage tank and filtering the sap. The method further includes concentrating the sap and treating the sap. The method additionally includes preparing a slurry and incubating the sap.

Another example embodiment includes a fertilizer containing banana sap. The fertilizer includes banana sap. The banana sap has been obtained by the steps of extracting fibrous materials from the banana plant pseudo-stem and separating the nonfibrous biomass and sap. The banana sap has also been obtained by the steps of filtering the sap and concentrating the sap. The banana sap has further been obtained by the steps of incubating the sap.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flow-chart illustrating an example of a method for creating a banana sap fertilizer; and

FIG. 2 is a flow-chart illustrating a method of extracting the fibrous material of a banana plant from the non-fibrous material.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

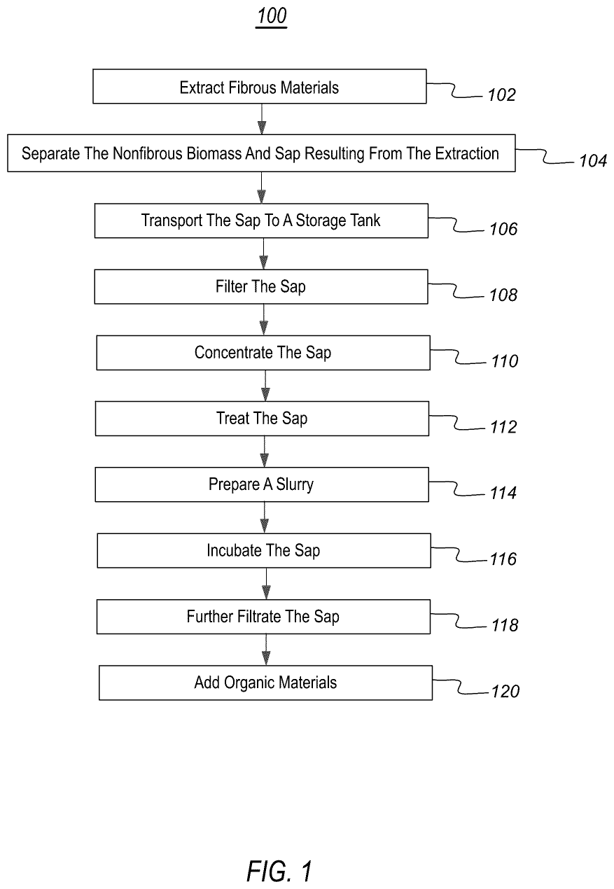

FIG. 1 is a flow-chart illustrating an example of a method 100 for creating a banana sap fertilizer. As used herein, fertilizer can include a standalone fertilizer, a bio-additive for other fertilizers, soil amendments or any other material which is intended to enhance plant growth or soil health. Banana sap fertilizer has a number of unique aspects that make it a novel and superior fertilizer for agriculture and commercial use compared to existing fertilizers. These unique features include:
a) It is highly nutrient-rich.
b) It assists in helping plants utilize existing organics and fertilizers.
c) It has the capacity to act as a disease suppressant thus protecting plant health.
d) It can be produced at a cost-competitive price.
e) It is found in high abundance in Central America and other areas through the industrialization of growing banana pseudo-stems rather than growing bananas for fruit.
f) It does not damage the soil but instead regenerates the soil. I.e., it encourages the growth of microorganisms which strengthen the soil.
g) It is renewable.
h) It can be grown and harvested throughout the year thereby providing a steady and consistent supply.
i) Its characteristics and qualities are not matched by existing soil amendments, garden mixes or materials to assist with plant growth.
j) It is rich in micronutrients including boron, copper, iron, magnesium and others that are extremely important for plant health.
k) Its production removes carbon dioxide from the atmosphere. This contrasts with other materials such as peat moss which unlock carbon dioxide, are non-renewable and as a result are being banned or limited throughout the world.

FIG. 1 shows that the method 100 can include extracting 102 fibrous materials. Extraction 102 primarily involves the separation of the fibrous strands found in the pseudo-stem and leaves of the plant from non-fibrous portions. The banana plant is not a tree but a large herb, and its pseudo-stem consists of tightly packed layers of leaf sheaths, which contain a considerable amount of fiber. Extraction 102 results in obtaining fibrous material and a combination of nonfibrous material and banana sap.

By way of explanation, banana plants consist of a pseudo-stem, which is not a true stem but rather a collection of tightly packed leaf sheaths. The pseudo-stem grows tall and can reach heights of up to 20 feet (6 meters) or more, depending on the variety. The actual stem is a rhizome that grows underground. This pseudo-stem is often referred to as the “trunk,” and will be referred to in this document as a trunk. Banana plants have large, elongated, and wide leaves that can be as long as 9 feet (2.7 meters) and about 2 feet (0.6 meters) wide. The leaves grow in a spiral pattern around the pseudo-stem, and as new leaves emerge, older ones gradually die off. In banana plants, the pseudo-stem is a prominent and unique feature that gives the plant its characteristic appearance. Contrary to what its name suggests, the pseudo-stem is not a true stem but a thick, succulent, and upright structure formed by the tightly packed leaf sheaths. It is sometimes referred to as a “false stem” because it performs similar functions to a traditional stem but is structurally different.

Here are some key points about the pseudo-stem in banana plants:
a) Appearance: The pseudo-stem is composed of overlapping leaf sheaths that tightly encircle each other. As the plant grows, new leaves emerge from the center, and older leaves wither and remain as a part of the pseudo-stem, forming visible rings.
b) Strength and Support: The pseudo-stem provides excellent structural support to the banana plant, allowing it to grow quite tall without the need for a woody trunk. Some banana varieties can reach heights of up to 20 feet (6 meters) or more.
c) Storage and Transport: The pseudo-stem also plays a crucial role in storing water and nutrients, which helps the plant survive in periods of drought or other adverse conditions. It acts as a conduit for transporting water and nutrients from the roots to the upper parts of the plant.
d) Reproduction: The pseudo-stem contributes to the plant's reproduction process. Once the banana plant reaches maturity, it produces a large inflorescence, also known as the banana heart, from the center of the pseudo-stem. The flowers within the inflorescence eventually develop into clusters of bananas.
e) Lifespan: The pseudo-stem has a limited lifespan. After the banana plant fruits, the pseudo-stem that bore the fruit begins to die back. However, the plant produces new suckers (offshoots) from its underground rhizomes, which will grow into new pseudo-stems which replace the old ones.
f) Harvesting: When bananas are cultivated for their fruit, the entire pseudo-stem is usually cut down after harvesting to make room for new shoots to grow. This process is part of the banana's cycle of growth and regeneration.

Overall, the pseudo-stem is a vital and fascinating part of banana plants, contributing to their structural stability, reproductive process, and ability to store and transport nutrients. Its unique characteristics are one of the reasons why banana plants are such intriguing and valuable crops in many parts of the world.

Banana plants require a tropical or subtropical climate with plenty of sunlight and well-drained soil. They are usually propagated through suckers, which are small shoots that grow from the base of mature plants. Banana plants are fast-growing, and under favorable conditions, they can produce fruit within 9 to 12 months. A typical hectare of bananas will have approximately 1,800 to 3,200 plants. By focusing on the offshoots, the banana plants can advance from one generation to the next. Once the fruit is harvested, the trunk is typically cut down to a height of about one meter. The residual trunk which is loaded with water and nutrients will nurture the next generation of pseudo-stems.

FIG. 1 also shows that the method 100 can include separating 104 the nonfibrous biomass and sap resulting from the extraction 102. The nonfibrous biomass and sap are placed into metal V-shaped trays. The sap drains into the bottom of the tray. I.e., gravity allows the sap to drain from the non-fibrous material, separating 104 the two components. In addition to extraction of or obtaining the sap through decortication, the sap may also be derived by shredding the entire pseudo-stem when the resulting shredded biomass is to be used for other purposes. Finally, the sap may be extracted through a tap or drain placed in a living plant. During the growth cycle of a plant, approximately two (2) quarts of sap can be drained from a plant prior to it being harvested. The method of obtaining the sap may vary depending on the objective. In most cases, the objective is to extract the fiber, and the sap becomes a byproduct of this process. However, if the objective is to use the biomass, the sap becomes the byproduct of the shredding process. Finally, using a tap or drain on a live plant may have independent benefits by increasing production of the sap through direct extraction from the plant.

FIG. 1 further shows that the method 100 can include transporting 106 the sap to a storage tank. In the simplest form, the tray can be tilted and the sap can drain off of the end of the tray and collected. Alternatively, the sap can be transported 106 through a tube system attached to the bottom of the tray. I.e., the sap is transported 106 through a series of tubes to a tank where the sap is stored and other refinement can occur.

FIG. 1 additional shows that the method 100 can include filtering 108 the sap. Filtering 108 separates dirt and grit from the sap. Filtering 108 can occur in the tray, during transporting 106 or in the storage tank. For example, the liquid sap can be passed through a falling film/tube where only sap is produced at the end of the tube.

FIG. 1 moreover shows that the method 100 can include concentrating 110 the sap. For example, multiple effect evaporators can be used to reduce the water content and make a high concentrated solution in the range of 40%-75% solids. This is helpful because the elimination of water reduces the volume of sap, making transportation easier and nutrient density higher.

FIG. 1 also shows that the method 100 can include treating 112 the sap. For example, the concentrated liquid can be treated 112 with rheology modifiers, pH adjusters, preservatives, bacterial activity promoters or any other desired treatment material. This treatment 112 allows for adjustments to be made to the concentration, balance of content and improve quality.

FIG. 1 further shows that the method 100 can include preparing 114 a slurry. The slurry can be prepared by passing the sap through a high shear centrifuge extractors to extract the liquid and store in the tank.

FIG. 1 additionally shows that the method 100 can include incubating 116 the sap. Incubation 116 includes the further addition of proprietary enzymes, plant-based surfactant and stains and further processed under controlled conditions of time, temperature and pH. Incubation 116 transforms the sap into a nutrient-rich liquid through a bio-digestion process that transforms the sap solution. Incubation 116 and bio-digestion at a high reactive temperature causes the solids to be mixed with the enzymes and surfactants to enhance the effectiveness and quality of the additive and to further enhance the capacity of the sap to maximize plant growth and development. Moreover, the incubation 116 and bio-digestion process further breaks down the solids so that they are in a micro-state to allow for application through a foliar or irrigation process. Examples of different types of incubation are discussed below.

FIG. 1 moreover shows that the method 100 can include further filtration 118 of the sap. The sap strained through a fine sieve or cloth to remove any solid pieces that may yet exist and obtain a more refined solution.

FIG. 1 also shows that the method 100 can include addition 120 of organic materials. The sap, depending on its intended use, could be simply used in its organic processed state, or may have a variety of organic materials added 120. These are the primary nutrients that plants need in relatively large quantities. The formulation would be determined by soil tests and/or through crop needs. Additives could include:
I. Nitrogen (N): Nitrogen is essential for the formation of proteins, enzymes, chlorophyll (which is crucial for photosynthesis), and many other vital plant compounds. It is crucial for overall growth and leafy green development.
II. Phosphorus (P): Phosphorus is necessary for energy transfer within the plant and plays a vital role in root development, flower and fruit formation, and overall plant growth.
Ill. Potassium (K): Potassium is involved in numerous physiological processes, including enzyme activation, water uptake and regulation, and overall plant health and disease resistance.
IV. Calcium (Ca): Calcium is essential for cell wall structure and stability, root development, and proper functioning of cell membranes.
V. Magnesium (Mg): Magnesium is a component of chlorophyll and is essential for photosynthesis, energy transfer, and enzyme activation.
VI. Sulfur (S): Sulfur is a constituent of some amino acids and proteins, and it plays a role in chlorophyll formation and overall plant health.

Some micronutrients for plant growth can be found in the sap. These are nutrients that plants require in smaller quantities but are still essential for their growth and development and do not need to be added or supplemented. These nutrients include:
a. Iron (Fe)
b. Manganese (Mn)
c. Zinc (Zn)
d. Copper (Cu)
e. Boron (B)
f. Molybdenum (Mo)
g. Chlorine (Cl)
h. Nickel (Ni)

Bio-chemicals such as gibberellic acid, Naphthalene Acetic Acid (NAA), cytokinin, and helpful bacteria such as phosphate solubilizing bacteria, Rhizobium, Azotobacter, and fungus, are all present in the banana sap of the banana pseudo-stem

One of skill in the art will appreciate that other steps can be undertaken to prepare the sap. For example, the additional steps can include the following:
a) Packaging: The additives are bottled in various sizes, ranging from small packages for home gardeners to large containers for commercial applications.
b) Labeling: Proper labeling is applied to each package, providing essential information such as the product's name, brand, weight, instructions for use, and any additional details or warnings.
c) Distribution: The bottled Banana sap fertilizer can be distributed to gardening centers, nurseries, commercial facilities, farmers and other retailers, where customers can purchase it for their specific needs.

Further, during application, the sap can be diluted with water. The sap can be readily used in its concentrated form or can be diluted with water before using it on plants. The ratio of water to fertilizer depends on the concentration desired and the specific requirements of the cultivation. A common ratio is 1 part sap fertilizer to 5-10 parts water.

Banana sap fertilizer can be used in a variety of ways and under different conditions. This flexible and versatile organic material has been shown to dramatically improve plants and soils. Examples of the use are as follows:
a) Banana sap fertilizer can be used for crops. Application can be done through the use of micro material being released and tilled into the soil.
b) Banana sap fertilizer can be used in commercial and residential landscaping. It can be mixed into the soil at a superficial level or used for the planting of ornamentals, trees or other plants and placed under and around the plant as it is planted in the soil. The organic material can be used for the landscaping around millions of commercial buildings and on residential properties.
c) Banana sap fertilizer can be used by state and local governments for maintenance of its green spaces, medians, parks, golf courses and buildings. Moreover, it can be used for all new plants, trees and ornamentals. This use will allow the government to use less water.
d) In drought-stricken areas, Banana sap fertilizer will help in reducing water usage by enhancing plant growth and maximizing plant development. Many jurisdictions require farmers, homeowners and businesses to eliminate certain water usage and banana sap fertilizer can promote root growth which reduces water usage.
e) Banana sap fertilizer is additionally an excellent fertilizer for arid areas such as arid states in the western United States or countries in the Middle East.
f) Banana sap fertilizer has been shown to be beneficial to strawberries, onions, corn, cabbage, soybean and other crops.

The invention of this banana sap fertilizer as a supplement to fertilizers is a tremendous addition to organic fertilizers. The banana sap fertilizer can be used in a concentrated form or diluted with water or combined with other fertilizer products. It is fused with unique organics from the banana pseudo-stem that promote nutrients for the soil and plants. This invention will further advance conservation while also promoting agriculture and commercial uses at a cost-competitive price.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

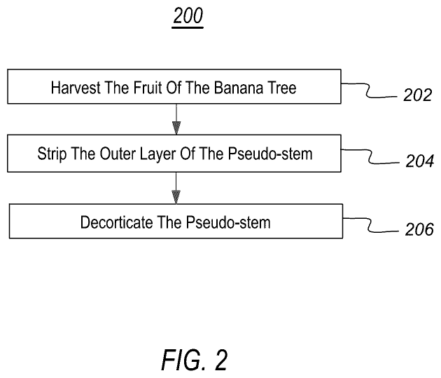

FIG. 2 is a flow-chart illustrating a method 200 of extracting the fibrous material of a banana plant from the non-fibrous material. The fibrous material can be used in other applications. Currently, the non-fibrous material is thrown away as organic waste.

FIG. 2 shows that the method 200 can include harvesting 202 the fruit of the banana tree. Banana plants are typically harvested 202 when the fruit is ready for consumption, usually when they are fully mature but still green. After the bananas are removed from the plant, the pseudo-stem and leaves are left behind for fiber extraction. Once the fruit is harvested 202 the pseudo-stem begins to die back.

FIG. 2 also shows that the method 200 can include stripping 204 the outer layers of the pseudo-stem. Stripping 204 includes removing the outer layers of the pseudo-stem and leaves. This can be done by hand or using tools such as a sharp knife or machete. The outer layers are discarded, leaving the fibrous core. The leaves are typically removed in the field and left as organic waste. A banana plant will have ten to fifteen layers making up the trunk or pseudo-stem.

FIG. 2 further shows that the method 200 can include decortication 206 of the pseudo-stem. Once the outer layers are removed, the fibrous core is carefully separated from the remaining plant material. Decortication 206 can be done manually by carefully peeling the fiber strands apart, or it can be achieved through mechanical methods. Decortication 206 is a process that involves removing the biomass from the separate layers to separate out the fiber contained within the pseudo-stem. The primary goal of decortication 206 is to separate the fibrous material, which can be used for various purposes, from the non-fibrous components.

Decortication 206 can be done through a decortication machine. The machine consists of a steel circular drum with a diameter of eighteen to thirty inches and a circumference of twelve to fourteen inches. The steel drum has teeth that are run across the drum at a separation distance of three to four inches. The teeth have a height of one-half inch to three-quarters of an inch. The drum is connected to a gas or electric motor that, when operated with belts, rotates the drum at a high speed. The pseudo-stem is cut into manageable sizes (usually in half but can be more for large plants). The layers are fed into the decortication machine, and the machine quickly captures the layer and pulls it forward. The operator typically pulls the layer back out. As the layer is pushed forward, the nonfibrous mass is stripped from the fiber and is discarded from the machine as biomass.

Because the banana plants consist of approximately eighty percent (80.0%) water, significant water sap is released during decortication 206 and becomes a byproduct with the nonfibrous biomass.

Different analyses have been performed of banana sap as a fertilizer, with results below. The analyses treated banana sap using a fermentation process. The fermentation is carried out in presence of microorganism like Azetobactor, Rhizobiun, Lactobaciluss, and Yeast at room temperature under anaerobic conditions. All the raw materials were purchased from local markets and used without further purification. All the raw materials originated either from plant sources or from animal sources. The list of raw materials used for the process is given in table 1, however the scope of raw materials available for inclusion in the fermentation process may vary depending on the location and availability of resources in a particular area or geographic region. The objective is to enhance the fermentation process through microorganisms which may exist beyond those identified herein.

TABLE 1

| Sr. no | Raw Material | Source | |
|---|---|---|---|
| 1 | Banana Sap | Plant | Commercial |
| 2 | Cow dung | Animal | Local market |
| 3 | Cow urine | Animal | Local market |
| 4 | Curd | Animal | Local market |
| 5 | Pulse floor | Plant | Local market |
| 6 | Jiggery (Organic) | Plant | Local market |
| 7 | Neem green leaves | Plant | Forest |
| 8 | Urea | Synthetic | Lab grade |
| 9 | Liquid consortia (bio fertilizer) | IFFCO Bazar | Commercial |

The composition of raw materials for batch 1 is given in table 2.

TABLE 2

| Sr. no | Chemical | Composition (%) | Quantity (gm) |
|---|---|---|---|
| 1 | Banana sap | 86.73 | 2499 |
| 2 | Liquid consortia | 4.33 | 125 |
| 3 | Cow Urine | 2.16 | 62 |
| 4 | Neem Green leaves | 4.33 | 125 |
| 5 | Curd | 2.16 | 62 |
| 6 | Pulse floor | 0.08 | 2.5 |
| 7 | Jaggary | 0.08 | 2.5 |

| | | |
|---|---|---|
| Total | 100 | 2880 |

The different batches were carried out to check the effect of composition and raw material on the total nitrogen, Kjeldahl nitrogen, Phosphorus and Potassium content. Also the raw banana sap was characterized for the same nutrients. The effectiveness of the fermentation process was evaluated based on banana sap and liquid fertilizer NPK contents. Fermentation for each batch was carried out in a closed glass reactor at 30-35° C. for a total of 30 days. The fermented liquid was collected by filtration. A total of 7 batches were conducted to prepare bio-fertilizer. Details are given in table 3.

TABLE 3

| Sr. no | Batch no | Changes made |
|---|---|---|
| 1 | 1 | Std. process with liquid consortia, cow urine |
| 2 | 2 | #01 with 50% liquid consortia, cow urine |
| 3 | 3 | #01 with cow dung as microbe source, cow urine |
| 4 | 4 | Cow dung as microbe source, cow urine |
| 5 | 5 | #01, with Urea as N source instead of cow urine |
| 6 | 6 | #01-Product as microbe source, and Urea |
| 7 | 7 | #04-Product as microbe source, and Urea |

After completion of fermentation process, sample of each batches was evaluated for NPK contents and compared the results with standard commercial a samples. The results are tabulated below.

TABLE 3

| | | Total | Kjeldahl | | | | | |
|---|---|---|---|---|---|---|---|---|
| Sr. | | nitrogen | nitrogen | Phosphorus | Potassium | | Density | Cost* |
| no | Batch no | mg/lit | mg/lit | mg/lit | mg/lit | pH | Gm/m. | $/kg |
| 1 | 1 | 411 | 380 | 10.8 | 2362 | 8.48 | 0.993 | 0.57 |
| 2 | 2 | 468 | 443.5 | 15 | 3390 | 7.91 | 0.997 | 0.54 |
| 3 | 3 | Not tested | | | | | | 0.49 |
| 4 | 4 | 1442 | 1442 | 5.68 | 0.49 | 7.86 | 0.996 | 0.49 |
| 5 | 5 | 798 | 798 | 18.62 | 1589 | 8.15 | 0.995 | 0.53 |
| 6 | 6 | 896 | 896 | 16.49* | 1399.6 | 8.10 | 0.996 | 0.46 |
| 7 | 7 | 756 | 756 | 18.33 | 1653 | 8.04 | 0.997 | 0.45 |

Standard sample

| | | | | | | | | |
|---|---|---|---|---|---|---|---|---|
| 1 | Greemanity | 506 | 490 | 12.7 | 1726 | 4.48 | 0.993 | NA |

Raw material

| | | | | | | | | |
|---|---|---|---|---|---|---|---|---|
| 1 | Banana Sap | 87 | 87 | 1.81 | 1470 | 7.6 | 0.997 | NA |

*Ram material costs are based on local markets and may change depending on the bulk market.

In the initial phase, the evaluation of organic liquid fertilizer is carried out on NPK values only. The nitrogen contents are higher when we use cow dung as a microbial source. However, phosphorous contents are lower. With both (liquid consortia and cow dung) microbial sources, potassium contents are higher in the product. This is because banana sap itself contains 1470 mg/lit potassium. This again highlights that the banana pseudo-stem sap is a potassium rich liquid. Density and pH are comparable for all results.

What is claimed is:

1. A method for creating a banana sap fertilizer, the method comprising:
obtaining sap from a banana plant;
filtering the sap;
concentrating the sap; and
incubating the sap.

2. The method of claim 1, wherein obtaining sap from a banana plant includes at least one of:
shredding the banana plant pseudo-stem and separating the sap; or
extracting sap from the banana plant pseudo-stem through a tap.

3. The method of claim 1, wherein obtaining sap from a banana plant includes:
extracting fibrous materials from the banana plant pseudo-stem and separating the nonfibrous biomass and sap.

4. The method of claim 3, wherein extracting fibrous materials from the banana plant pseudo-stem may include harvesting the fruit of the banana plant.

5. The method of claim 3, wherein extracting fibrous materials from the banana plant pseudo-stem further includes stripping the outer layers of the pseudo-stem and leaves.

6. The method of claim 5, wherein extracting fibrous materials from the banana plant pseudo-stem further includes decortication.

7. The method of claim 6 wherein decortication includes peeling the fiber strands apart.

8. The method of claim 6 wherein decortication includes using a decortication machine.

9. The method of claim 1 further comprising:
packaging the sap;
labeling the sap; and
distribution of the sap.

10. A method for creating a banana sap fertilizer, the method comprising:
extracting fibrous materials from the banana plant pseudo-stem;
separating the nonfibrous biomass and sap;
transporting the sap to a storage tank;
filtering the sap;
concentrating the sap;
treating the sap;
preparing a slurry; and
incubating the sap.

11. The method of claim 10, wherein transporting the sap includes moving the sap through a tube system.

12. The method of claim 10, wherein treating the sap includes adding at least one of:
a rheology modifiers;
a pH adjusters;
a preservative; or
a bacterial activity promoters

13. The method of claim 10, wherein prepare a slurry includes passing the sap through a high shear centrifuge.

14. The method of claim 10 further comprising additional filtration after incubation.

15. The method of claim 10 further comprising addition of organic materials.

16. The method of claim 10 wherein the added organic materials include at least one of:
Nitrogen;
Phosphorus;
Potassium;
Calcium;
Magnesium; or
Sulfur.

17. The fertilizer of claim 10, wherein incubating the sap includes:
fermenting in the presence of at least one of:
Azetobactor;
Rhizobiun;
Lactobaciluss; or
Yeast;
wherein the fermentation occurs at room temperature under anaerobic conditions.

18. A fertilizer containing banana sap, the fertilizer comprising:
banana sap, wherein the banana sap has been obtained by the steps of:
extracting fibrous materials from the banana plant pseudo-stem;
separating the nonfibrous biomass and sap;
filtering the sap;
concentrating the sap; and
incubating the sap.

19. The fertilizer of claim 18, wherein the fertilizer further includes at least one of:
Nitrogen;
Phosphorus;
Potassium;
Calcium;
Magnesium; or
Sulfur.

20. The fertilizer of claim 18, wherein the fertilizer further includes at least one of:
Iron;
Manganese;
Zinc;
Copper;
Boron;
Molybdenum;
Chlorine; or
Nickel.
